(19) United States
(12) Patent Application Publication
(10) Pub. No.: US 2011/0081197 A1
(43) Pub. Date: Apr. 7, 2011

(54) JUNCTION ELEMENT

(75) Inventors: Thomas Buschjohann, Nordstemmen (DE); Franz Friedrich Butz, Hildesheim (DE); Edvin List Clausen, Abenra (DK); Kathy Hansen, Tonder (DK)

(73) Assignee: KSM Castings GmbH, Hildesheim (DE)

(21) Appl. No.: 12/737,115

(22) PCT Filed: Jun. 4, 2009
(86) PCT No.: PCT/DE2009/000779

§ 371 Date: Dec. 9, 2010

(30) Foreign Application Priority Data
Jun. 11, 2008 (DE) 10 2008 027 739.8
Jun. 13, 2008 (DE) 102008 028 390.8
Jun. 27, 2008 (DE) 10 2008 030 600.2
Sep. 17, 2008 (DE) 10 2008 047 474.6

(51) Int. Cl. B62D 21/00

(52) U.S. Cl. 403/345

(57) ABSTRACT

The invention relates to a junction element (10) for connecting a plurality of hollow profiles (12, 14) in a frame structure, in particular for a motor vehicle.

The invention relates to a junction element according to the preamble of claim 1.

Frame constructions that comprise hollow profiles that are connected by way of junction elements are known as such.

Known frame constructions are, for example, the auxiliary frames for motor vehicles that are also called subframes. The longitudinal and transverse beams that form the frame construction, in this connection, are known to be produced from light metal, particularly from aluminum and aluminum alloys, and are firmly connected with one another by way of junction elements or cast joints produced from a light-metal casting material.

In particular, when structuring the auxiliary frame for a motor vehicle with longitudinal and transverse beams made of light metal, with corresponding cast joints made of a light metal material, such as cast aluminum or alloys of it, for example, the cast joint proves to be disadvantageous with regard to the crash requirements that must be met.

If the auxiliary frame for a motor vehicle, and here, in particular, the front axle auxiliary frame, is used for the conversion of crash energy in the event of an accident, the cast joints tend to fail prematurely.

In the event of an accident, only the longitudinal and transverse beams, which are generally configured as extruded profiles made of a light metal, demonstrate sufficient ductility to absorb the crash energy.

Furthermore, junction elements for connecting hollow profiles are known, which consist of a plurality of extruded profiles, in other words of a plurality of individual parts, in order to produce the required geometry with sufficient connection points. These extruded profiles are joined together in complicated manner, as an aluminum welded construction.

The invention is based on the task of further developing a junction element according to the preamble of claim 1, while avoiding the stated disadvantages, in such a manner that this element demonstrates not only great stability but also great functionality.

This task is accomplished with a junction element according to the characteristics of claim 1, 3, or 4. The dependent claims, in each instance, relate to particularly practical embodiments of the invention.

According to the invention, the junction element comprises an extruded profile and a cast piece.

By means of this combination, a junction element having great stability and great functionality is made available. By means of the invention, it is possible to make available a region of the junction element that is able to withstand great stress, in the form of the cast piece, particularly for a car body connection. On the basis of the configuration of the degrees of freedom that one has in casting, in other words the design degrees of freedom, the cast piece can be designed in accordance with the stress. By means of connecting the cast piece with the preferably complicated extruded profile, very good mechanical technological characteristic values are furthermore achieved. The production of the extruded profile furthermore requires only few tests and therefore causes little cost.

In the case of a vehicle, failure of the junction elements, specifically of the cast piece, is furthermore prevented in the event of an accident. This is because in this connection, the extruded profile of the junction element absorbs higher proportions of the crash energy.

Preferably, the junction element additionally comprises a sheet-like reinforcement element, particularly preferably in the form of a sheet-metal part.

The latter can be produced in particularly advantageous manner. By means of this combination, a junction element having great stability and great functionality is made available.

It is practical if the junction element consists only of an extruded profile and a cast piece.

By means of this combination, a junction element having great stability and great functionality is made available. By means of the invention, it is possible to make available a region of the junction element that is able to withstand great stress, in the form of the cast piece, particularly for a car body connection. On the basis of the configuration of the degrees of freedom that one has in casting, in other words the design degrees of freedom, the cast piece can be designed in accordance with the stress. By means of connecting the cast piece with the preferably complicated extruded profile, very good mechanical technological characteristic values are furthermore achieved. The production of the extruded profile furthermore requires only few tests and therefore causes little cost.

In the case of a vehicle, failure of the junction elements, specifically of the cast piece, is furthermore prevented in the event of an accident. This is because in this connection, the extruded profile of the junction element absorbs higher proportions of the crash energy.

Alternatively, the junction element consists only of an extruded profile, a cast piece, and a sheet-like reinforcement element, preferably in the form of a sheet-metal part.

By means of this combination, a junction element having great stability and great functionality is made available. By means of the invention, it is possible to make available a region of the junction element that is able to withstand great stress, in the form of the cast piece, particularly for a car body connection. On the basis of the configuration of the degrees of freedom that one has in casting, in other words the design degrees of freedom, the cast piece can be designed in accordance with the stress. By means of connecting the cast piece with the preferably complicated extruded profile, very good mechanical technological characteristic values are furthermore achieved. The production of the extruded profile furthermore requires only few tests and therefore causes little cost.

In the case of a vehicle, failure of the junction elements, specifically of the cast piece, is furthermore prevented in the event of an accident. This is because in this connection, the extruded profile of the junction element absorbs higher proportions of the crash energy.

It is practical if the stated components of the junction element are joined together by means of suitable connection methods.

It is advantageous if the components of the junction element are joined together with force fit, shape fit and/or material fit, but preferably by means of welding, at least in partial regions.

It is advantageous if the components of the junction element are produced from light metal, preferably from aluminum or an aluminum alloy, particularly preferably from GD-AlSi10Mg T5.

It is practical if the cast piece is produced from light metal, preferably from an aluminum alloy, particularly preferably using the die-casting method.

The cast piece preferably consists of a weldable die-casting alloy.

The sheet-metal part is preferably connected with the extruded profile in the manner of a lid.

The lid increases the rigidity of the construction. Hollow structures can be formed, which allow such rigidity.

It is practical if the sheet-metal part has one or more reinforcement ribs, belts, beads, bulges, crosspieces and/or perforations, but preferably one or more reinforcement beads.

It is advantageous if the sheet-like reinforcement element, preferably in the form of a sheet-metal part, essentially covers the extruded profile.

It is practical if the sheet-like reinforcement element is part of the cast piece.

It is practical if the cast piece is disposed to the side of the extruded profile, but preferably partly to the side and partly on the extruded profile.

It is advantageous if the cast piece has one or more reinforcement ribs, belts, beads, bulges, crosspieces and/or reinforcement perforations in the region that can withstand great stress.

Preferably, the extruded profile has multiple chambers.

It is practical if the cast piece and/or the extruded profile has/have recesses for the hollow profiles to be connected.

The frame construction is preferably a structural part of a vehicle body, such as, for example, a front-axle support, rear-axle support, auxiliary frame, longitudinal or transverse beam module, but preferably the front-axle support.

It is practical if it is provided that the cast piece has connection points, particularly for connections to the body of a vehicle.

Furthermore, it is provided that the components of the junction element has one or more accommodations, screw-on points and/or attachment points for possible attachment parts.

The cast piece preferably has an accommodation for a connection point of the extruded profile on its underside, which accommodation aligns with the connection point for connecting to the body of a vehicle.

The invention will be described in greater detail using the exemplary embodiments shown in the drawing. This shows:

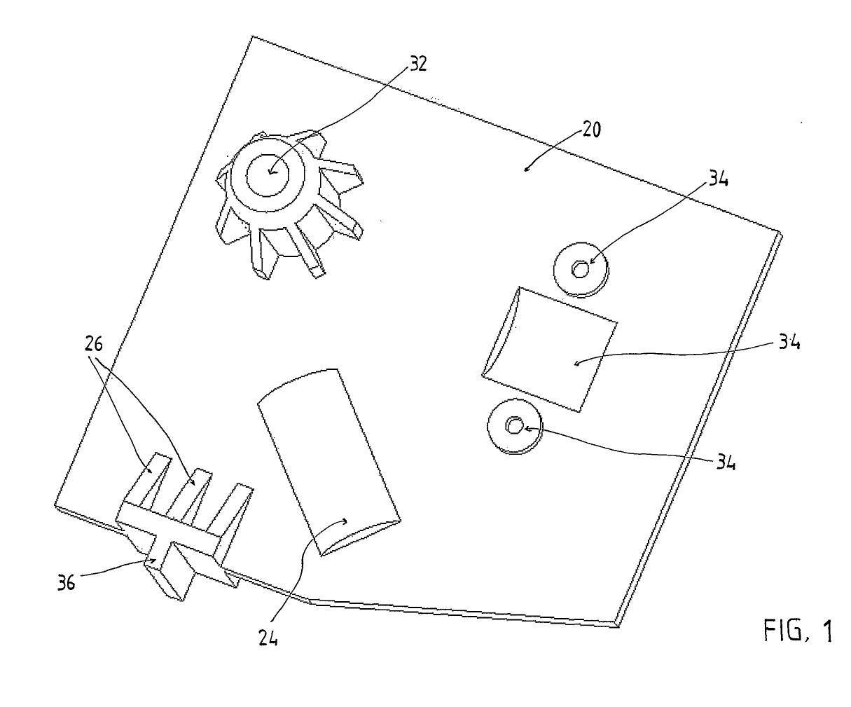

FIG. 1 an embodiment of the cast piece with a sheet-like reinforcement element as part of the junction according to the invention, in a viewing direction from above, at a slant,

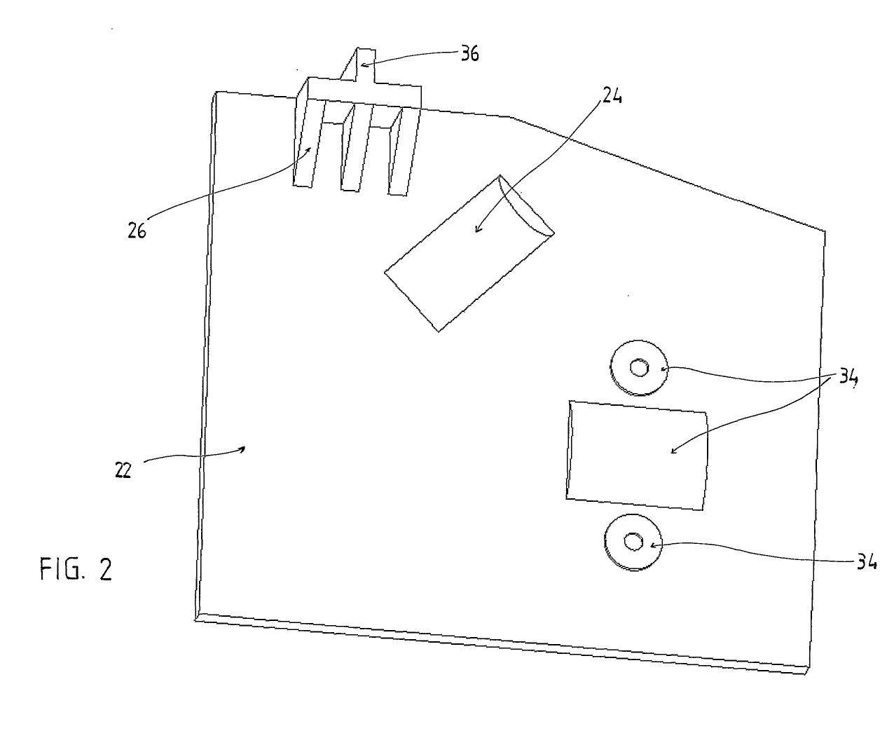

FIG. 2 the cast piece according to FIG. 1, in a viewing direction from below, at a slant,

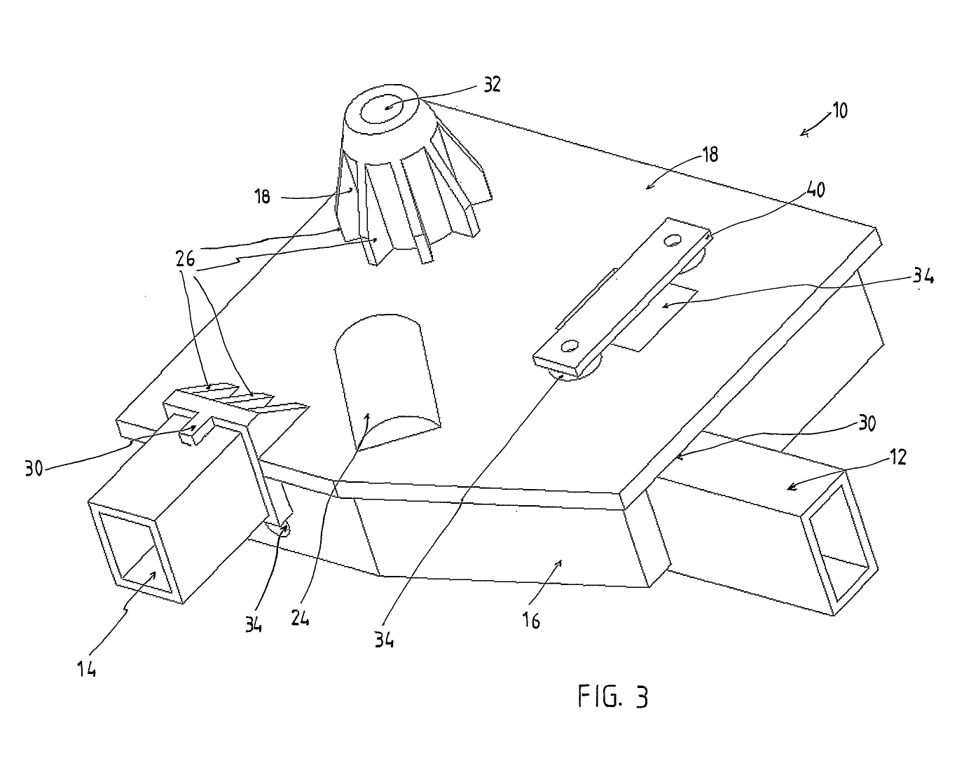

FIG. 3 the junction element according to the invention with the cast piece according to FIG. 1 and extruded profile, as well as two hollow profiles, along with attachment parts, in a viewing direction from above, at a slant,

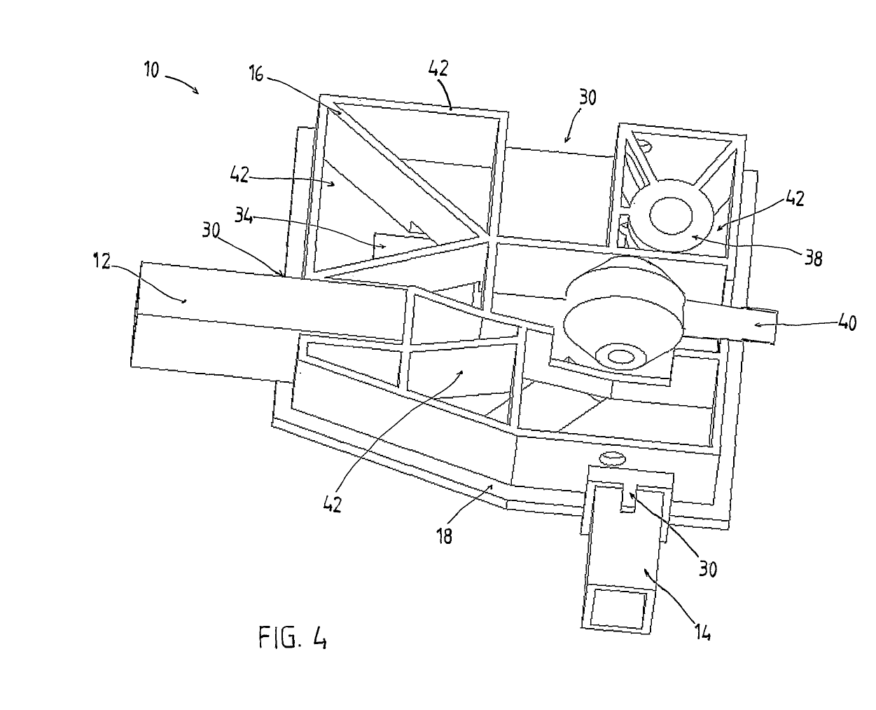

FIG. 4 the junction element according to the invention as in FIG. 3, in a viewing direction from below,

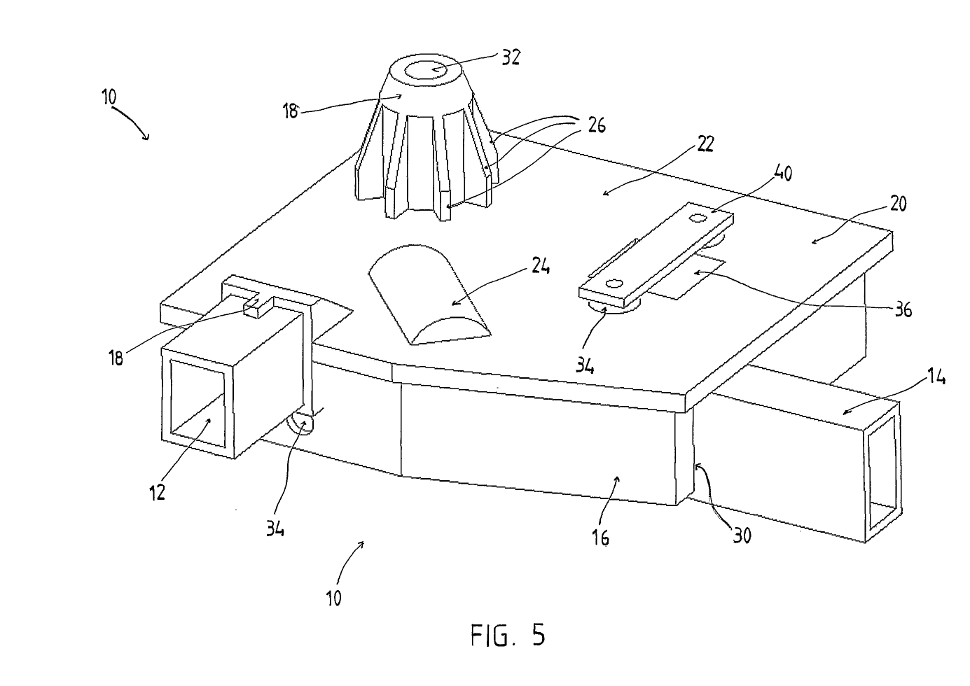

FIG. 5 the junction element according to the invention, composed of cast piece, extruded profile, and sheet-metal part, in a first viewing direction from the side, from above, at a slant,

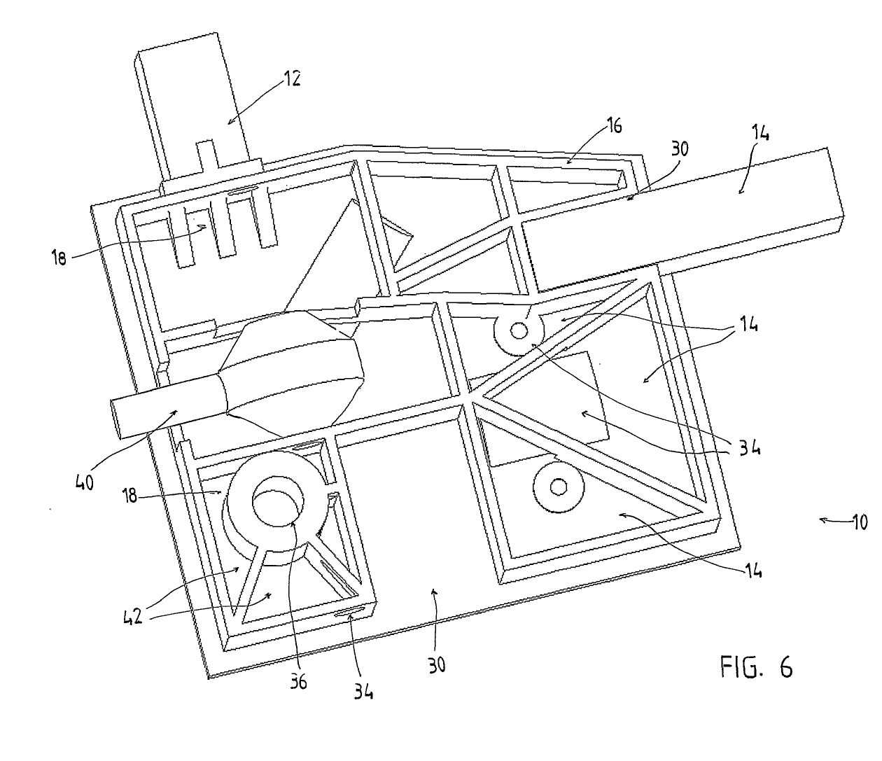

FIG. 6 the junction element according to the invention as in FIG. 5, in a viewing direction from below.

The description relates to all of FIGS. 1-6. In this connection, the same reference numbers relate to the same components.

The invention relates to a junction element 10 for connecting multiple hollow profiles 12, 14 of a frame construction, not shown here, particularly for a motor vehicle. Such a frame constructions can be, for example, and here preferably, a front-axle support, the longitudinal and transverse profiles 12, 14 of which are produced from light metal, and are firmly connected with one another, at least in part, by way of junction elements 10 according to the invention.

The junction element 10 according to the invention consists of an extruded profile 16, a cast piece 18, and a sheet-like reinforcement element 20. In FIGS. 1 to 4, the sheet-like reinforcement element 20 is part of the cast piece. In the preferred variant, the sheet-like reinforcement element 20 is a separate sheet-metal part 22, as shown in FIGS. 5 and 6.

The components 16, 18, 20, 22 of the junction element are joined together with shape fit and/or material fit, but preferably by means of welding, at least in predetermined partial regions.

It is practical if the hollow profiles 12, 14 are connected with the junction element 10 with shape fit, force fit and/or material fit.

The components 16, 18, 20, 22 of the junction element are produced from light metal, preferably from aluminum or an aluminum alloy. In this connection, the cast piece is produced using the die-casting method, whereby the die-casting alloy is weldable.

The sheet-like reinforcement element 20 or the sheet-metal part 22 is connected with extruded profile 16 in the manner of a lid. In this way, particularly great rigidity is achieved.

The sheet-like reinforcement element 20 or the sheet-metal part 22 has multiple reinforcement beads 24 in order to increase its rigidity.

The cast piece 18 itself is disposed to the side of the extruded profile 16. If the sheet-like reinforcement element 20 is part of the cast piece 18, the cast piece 16 is, of course, disposed not just to the side but also on the extruded profile 16.

In the region that can withstand great stress, in this case at the connection point 32 to the car body, the cast piece 18 has multiple reinforcement crosspieces 26 as well as a reinforcement perforation 28.

To increase the stability of the junction element 10, the extruded profile 16 has multiple chambers 42, which are open on one side after it has been covered by the sheet-like reinforcement element 20.

The extruded profile 18 furthermore has accommodations 30 for the hollow profiles 12, 14 to be connected.

It is practical if the components 16, 18, 20, 22 of the junction element 10 furthermore have one or more accommodations, screw-on points and/or attachment points for possible attachment parts 40, as shown in FIGS. 3 and 4.

The cast piece 18 furthermore has an accommodation 36 for a connection point 38 of the extruded profile 16 on its underside, which accommodation aligns with the connection point 32 for connecting to the body of the vehicle.

Of course, all the parts described above can be claimed as being essential to the invention, in themselves alone or in any combination, particularly the details shown in the drawing. Modifications of this are familiar to a person skilled in the art.

### REFERENCE SYMBOL LIST

10 junction element
12 hollow profile
14 hollow profile
16 extruded profile
18 cast piece
20 sheet-like reinforcement element
22 sheet-metal part
24 reinforcement bead
26 reinforcement crosspiece
28 reinforcement perforation
30 accommodation for hollow profile
32 connection point
34 accommodation, screw-on point, attachment point
36 accommodation
38 connection point
40 attachment parts
42 chamber

1. Junction element (10) for connecting multiple hollow profiles (12, 14) in a frame construction, particularly for a motor vehicle, wherein the junction element (10) comprises an extruded profile (16) and a cast piece (18).

2. Junction element (10) according to claim 1, wherein the junction element (10) additionally comprises a sheet-like reinforcement element (20), particularly in the form of a sheet-metal part (22).

3. Junction element (10) according to claim 1, wherein the junction element (10) consists of an extruded profile (16) and a cast piece (18).

4. Junction element (10) according to claim 1, wherein the junction element (10) consists of an extruded profile (16), a cast piece (18), and a sheet-like reinforcement element (20), preferably in the form of a sheet-metal part (22).

5. Junction element (10) according to claim 1, wherein the components (16, 18, 20, 22) of the junction element (10) are joined together by means of suitable connection methods.

6. Junction element (10) according to claim 1, wherein the components (16, 18, 20, 22) of the junction element (10) are joined together with force fit, shape fit and/or material fit, but preferably by means of welding, at least in partial regions.

7. Junction element (10) according to claim 1, wherein the components (16, 18, 20, 22) of the junction element are produced from light metal, preferably from aluminum or an aluminum alloy, particularly preferably from GD-AlSi10Mg T5.

8. Junction element (10) according to claim 1, wherein the cast piece (18) is produced from light metal, preferably from an aluminum alloy, particularly preferably using the die-casting method.

9. Junction element (10) according to claim 1, wherein the cast piece (18) consists of a weldable die-casting alloy.

10. Junction element (10) according to claim 1, wherein the sheet-metal part (22) is connected with the extruded profile (16) in the manner of a lid.

11. Junction element (10) according to claim 1, wherein the sheet-metal part (22) has one or more reinforcement ribs, belts, beads, bulges, crosspieces and/or perforations, but preferably one or more reinforcement beads (24).

12. Junction element (10) according to claim 1, wherein the sheet-like reinforcement element (20) essentially covers the extruded profile (16), preferably in the form of a sheet-metal part (22).

13. Junction element (10) according to claim 1, wherein the sheet-like reinforcement element (20) is part of the cast piece (18).

14. Junction element (10) according to claim 1, wherein the cast piece (18) is disposed to the side of the extruded profile (16), but preferably partly to the side and partly on the extruded profile (16).

15. Junction element (10) according to claim 1, wherein the cast piece (18) has one or more reinforcement ribs, belts, beads, bulges, crosspieces (26) and/or reinforcement perforations in the region that can withstand great stress.

16. Junction element (10) according to claim 1, wherein the extruded profile (16) has multiple chambers (42).

17. Junction element (10) according to claim 1, wherein the cast piece (18) and/or the extruded profile (16) has/have accommodations (30) for the hollow profiles (12, 14) to be connected.

18. Junction element (10) according to claim 1, wherein the frame construction is a structural part of a vehicle body, such as, for example, a front-axle support, rear-axle support, auxiliary frame, longitudinal or transverse beam module, but preferably the front-axle support.

19. Junction element (10) according to claim 1, wherein the cast piece (18) has connection points (32), particularly for connecting to the body of a vehicle.

20. Junction element (10) according to claim 1, wherein the components (16, 18, 20, 22) of the junction element (10) have one or more accommodations, screw-on points and/or attachment points for possible attachment parts (40).

21. Junction element (10) according to claim 1, wherein the cast piece (18) has an accommodation (36) for a connection point (38) of the extruded profile (16) on its underside, which accommodation aligns with the connection point (32) for connecting to the body of a vehicle.

22. Junction element (10) according to claim 1, wherein the cast piece (18) has an accommodation or recess for a longitudinal beam or the like, whereby the accommodation or recess preferably has a support surface that is delimited by two reinforcement walls.
